(19) United States
(12) Patent Application Publication
(10) Pub. No.: US 2026/0230479 A1
(43) Pub. Date: Aug. 6, 2026

(54) System and Method for Generating Traceable Security Points on Compromised Documents

(71) Applicant: Business Research and Development, Riyadh (SA)

(72) Inventor: Abdullah Aldosari, Riyadh (SA)

(21) Appl. No.: 19/042,989

(22) Filed: Jan. 31, 2025

(51) Int. Cl. H04L 9/40; G06F 21/62

(52) U.S. Cl. CPC H04L 63/105; G06F 21/6218; H04L 63/1425

(57) ABSTRACT

A method and system for generating traceable security points on documents leaked by an individual. The method scans documents with a camera that a company or government wants to protect. The documents are then stored on a server and each time an individual accesses the documents, security points are integrated inro the accessed document. The company or government may then scan a leaked document, wherein the leaked document is then checked against a storage database for a potential match. If a match occurs, a notification is sent to the company or government, indicating which individual leaked the document.

### FIELD OF THE INVENTION

The present invention relates generally to a system and method that generates traceable security points to protect documents. More specifically, the present invention links the security point location with a user to identify the user who leaks a document.

### BACKGROUND OF THE INVENTION

The phenomenon of leaking documents, papers, and web pages has recently become widespread in an easy and non-traceable manner, following the availability of modern social media technology. This causes significant embarrassment for organizations attempting to identify the source of the leak.

The present invention system and method adopts the principle of protecting documents and images when they are leaked or published to track the source of the image and identify who leaked or published it. This is achieved by creating a plurality of points on all documents and images that the administrator account requests to protect.

### BRIEF DESCRIPTION OF THE DRAWINGS

FIG. 1 is an illustration of the system of the present invention.

FIG. 2 is an illustration of the system of the present invention.

FIG. 3 is a block diagram the present invention.

FIG. 4 is a flowchart of the present invention.

FIG. 5 is a flowchart of the present invention.

FIG. 6 is a flowchart of the present invention.

FIG. 7 is a flowchart of the present invention.

FIG. 8 is a flowchart of the present invention.

FIG. 9 is an example illustration of a plurality of security points on a grid.

### DETAILED DESCRIPTION OF THE INVENTION

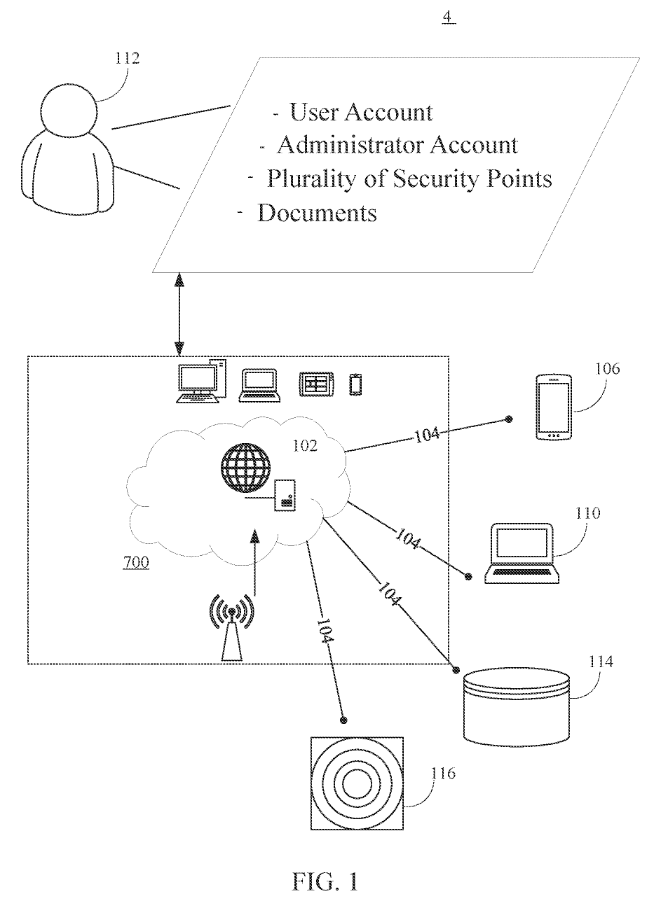

FIG. 1 is an illustration of an online server 4 consistent with various embodiments of the present disclosure. By way of non-limiting example, the online server 4 to enable generating traceable security points may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online server 4 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online server 4 through a web-based software application or browser. The web-based software application may be embodied as, for example, but not be limited to, a website, a web application, a desktop application, and a mobile application compatible with a computing device 200.

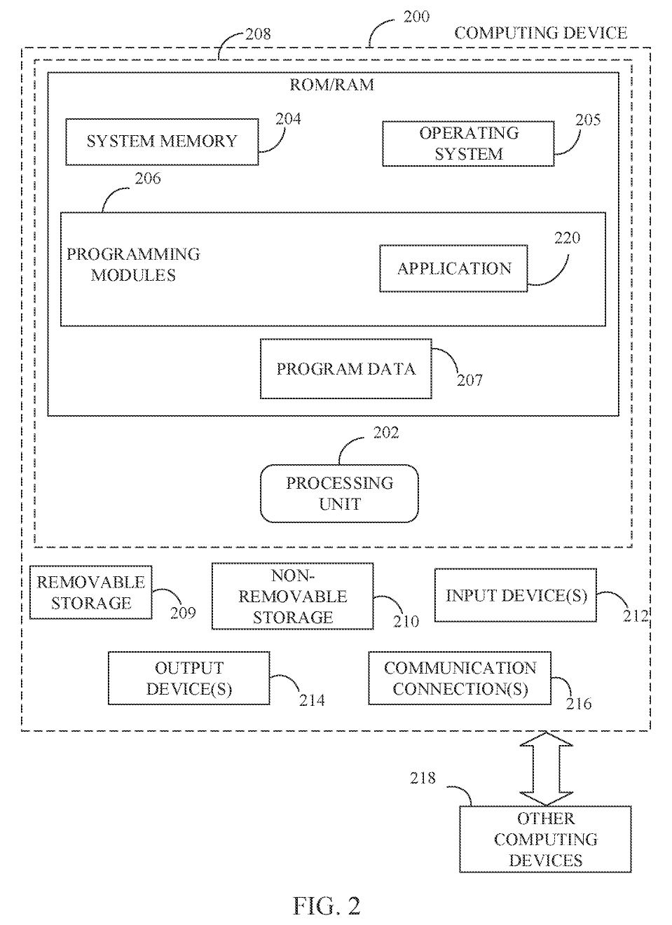

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200’s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera 3, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

As shown in FIG. 1-9, the present invention is a system for generating traceable security points on compromised documents 47. Accordingly, the system comprises a user device 1, an administrator device 2, a camera 3, and an online server 4. Further the online server 4 further comprises storage database 41, a plurality of security points 42, a user account 43, an administrator account 44, at least one clean document 45, at least one edited document 46, and at least one compromised document 47. The edited document 46 is a document that contains a plurality of security points 42. The compromised document 47 is also a document that contains a plurality of security points 42 but has also been leaked without authorization by a user account 43. The camera 3 may be configured to be in remote communication with the user device 1 and the administrator device 2. This enables the camera 3 to send data to the user device 1 and administrator device 2. The user device 1 and administrator device 2 may be configured to be in remote communication with the online server 4. As a result, the user device 1 and the administrator device 2 may send data to the online server 4 and access data along the online server 4. The user device 1 is able to access at least one edited document 46 and at least one compromised document 47 on the online server 4. Thus, the user device 1 may read, print and download documents that are hosted on the online server 4. The administrator device 2 is able to access at least one clean document 45, at least one edited document 46, and at least one compromised document 47 on the online server 4. So, the administrator device 2 may upload a clean document 45 and further access and compare additional documents to identify the user who leaked a specific document.

Further, the system may include the storage database 41 which further comprises a plurality of security points data 411. The plurality of security points data 411 is an indicator that tracks who, how and where a document was accessed. The plurality of security points data 411 is associated with a plurality of security points 42 on at least one edited document 46 or at least one compromised document 47. The user account 43 is associated with the user device 1. As a result, the plurality of security points data 411 identifies which user device 1 and associated user account 43 has accessed which documents. The administrator account 44 is associated with the administrator device 2. Thus, the administrator account 44 is able to upload documents and receive data on who is accessing certain documents.

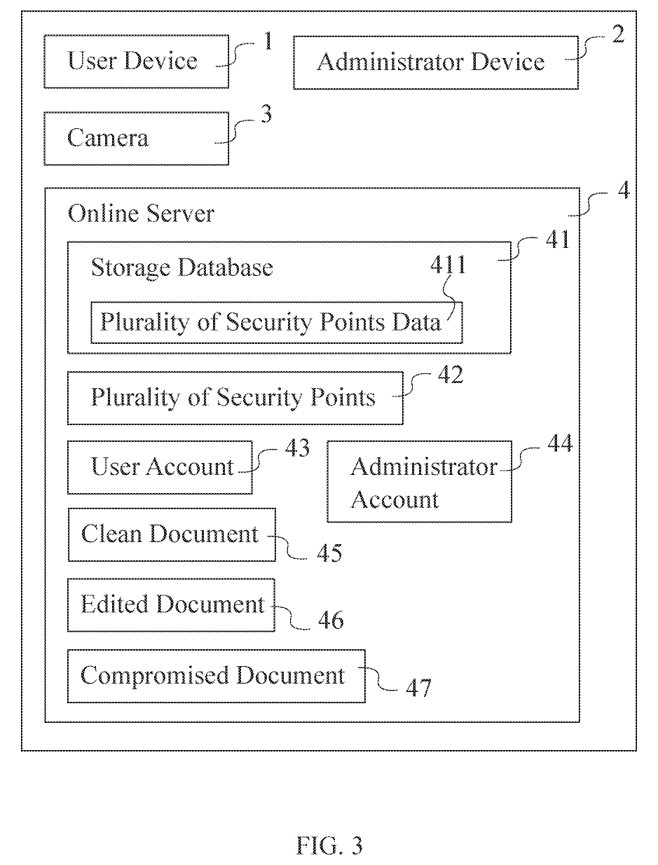

The present invention further comprises the camera 3, which records a clean document 45 as seen in FIG. 3. The camera 3 records a compromised document 47. As a result, the camera 3 enables the administrator account 44 to record two types of documents, one for storage and protection wherein the other is uploaded for analyzation. The administrator device 2 uploads the clean document 45 to the online server 4 via the administrator account 44. The administrator device 2 uploads the compromised document 47 to the online server 4 via the administrator account 44. Consequently, the user account 43 may access an uploaded clean document 45 once converted into an edited document 46. Furthermore, the plurality of security points 42 is integrated within the edited and compromised document 47. Accordingly, once a clean document 45 is uploaded to the online server 4 the clean document 45 is transformed into an edited document 46 once the plurality of security points 42 is integrated into the document. At this point the edited document 46 looks the same and functions similarly to a compromised document 47. In order for an edited document 46 to transform into a compromised document 47, the edited document 46 must be accessed and leaked by a user account 43.

As can be seen in FIG. 1-9, the preferred embodiment of the present invention is a method for generating traceable security points on compromised documents 47. The method of the present invention places a plurality of security points 42 along a clean document 45 to form an edited document 46. In an alternative embodiment the method of the present invention then a compares a compromised document 47 with the plurality of security points data 411 in a storage database 41. The method of the present invention may simply enter a document reference number along with a matrix to identify if a document has been leaked and by who. In this way, the present invention is a system and method for integrating security points into documents accessed by a user, enabling the user to easily be tracked down if the document is later leaked.

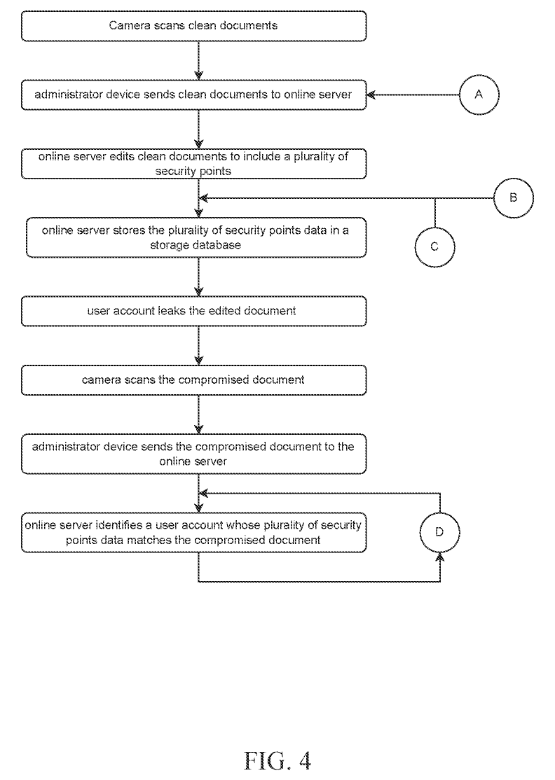

As can be seen in FIG. 4, the system used to execute the method of the present invention allows the present invention to generate and track a plurality of security points 42. To accomplish this, the method of the present invention scans, using a camera 3, at least one clean document 45. Next the method sends, using an administrator device 2, a clean document 45 to an online server 4. Next the method edits, using the online server 4, the clean document 45 to include a plurality of security points 42 once the clean document 45 is accessed and opened by the user account 43. The plurality of security points 42 are applied to the clean document 45 whenever the user account 43 accesses the clean document 45 and not when the clean document 45 is uploaded to the online server 4. Then the method stores, using the online server 4, a plurality of security points data 411 in a storage database 41. Later the method leaks, using the user account 43, an edited document 46. Next the method scans, using the camera 3, a compromised document 47. Then the method sends, using the administrator device 2, the compromised document 47 to the online server 4. Finally, the method identifies, using the online server 4, the user account 43 whose plurality of security points data 411 matches the compromised document 47.

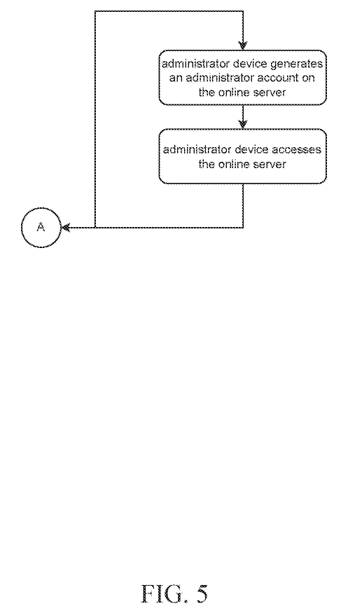

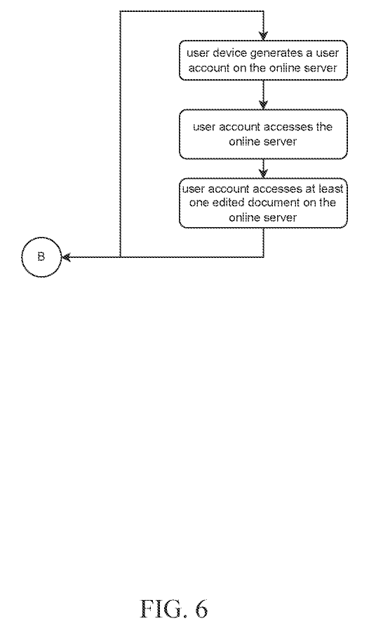

As can be seen in FIG. 5-6, the method of the present invention allows the present invention to generate accounts to be utilized on the online server 4. To accomplish this, the method of the present invention generates, using the administrator device 2, an administrator account 44 on the online server 4. Then the method enables, using the administrator account 44, the administrator device 2 to access the online server 4. The administrator account 44 enables the administrator to upload clean documents 45, access edited documents 46, and analyze compromised documents 47. The system used to execute the method of the present invention generates, using the user device 1, a user account 43 on the online server 4. The method then enables, using the user account 43, the user device 1 to access online server 4. The user account 43 enables the user to access edited documents 46, wherein the user may read, print or download said edited documents 46. Next the method accesses, using the user account 43, at least one edited document 46 on the online server 4.

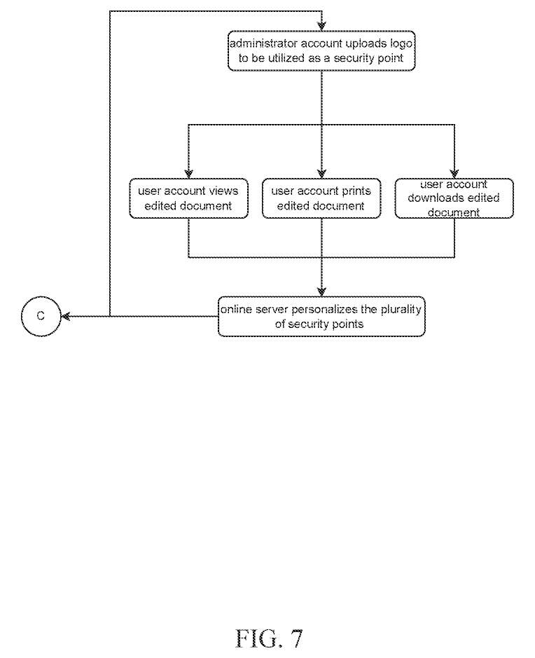

In reference to FIG. 7, a sub-process of the method of the present invention enables the administrator to customize the appearance of their plurality of security points 42. To that end, the sub-process begins by uploading, using the administrator account 44, a logo. The logo may be any colored image selected by the administrator such as a company logo or government seal. The sub-process continues by utilizing, using the administrator account 44, the logo as a security point. The logo is then integrated and utilized as a security point within the plurality of security points 42, so that the logo will display along the document wherein necessary. The sub-process continues by personalizing, using the online server 4, the plurality of security points 42 on the edited document 46 based on which user account 43 accessed the edited document 46. As a result, the plurality of security points 42 is arranged in different manners based on which user account 43 accesses the edited document 46 and at what time.

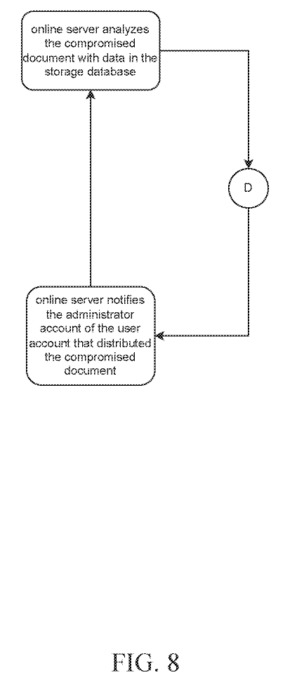

In reference to FIG. 7-8, a sub-process of the method of the present invention enables the plurality of security points 42 to indicate the method of which the user accessed and distributed the edited document 46. To that end, the sub-process begins by prompting generating, using the administrator device 2, a different plurality of security points 42 on the edited document 46 if the user account 43 prints the edited document 46. The plurality of security points 42 is adjusted to indicate that the user printed the edited document 46. The sub-process continues by generating, using the administrator device 2, a different plurality of security points 42 on the edited document 46 if the user account 43 views the edited document 46. The plurality of security points 42 is adjusted to indicate that the user viewed the edited document 46. The sub-process continues by generating, using the administrator device 2, a different plurality of security points 42 on the edited document 46 if the user account 43 downloads the edited document 46. The plurality of security points 42 is adjusted to indicate that the user downloaded the edited document 46. The sub-process continues by analyzing, using the online server 4, the compromised document 47 with respect to the plurality of security points data 411 in the storage database 41. The sub-process continues by notifying, using the online server 4, the administrator account 44 of the user account 43 that distributed the compromised document 47. Once a user account 43 is identified as having released an edited document 46, the user account 43 information is then distributed to the administrator account 44.

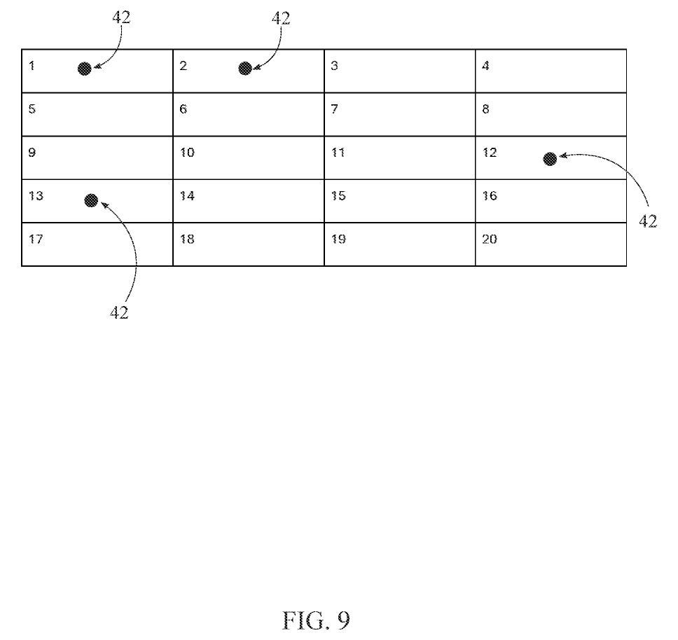

In reference to FIG. 9, a sub-process of the method of the present invention enables the plurality of security points 42 to be randomly generated and associated with each user account 43. To that end, the sub-process begins by generating, using the online server 4, an x variable that represents the x-axis. Therefore, x is the x-axis value along the edited document 46. The sub-process continues by generating, using the online server 4, a y variable that represents the y axis. Therefore, y is the y-axis value along the edited document 46. The sub-process continues by generating, using the online server 4, a K variable that represents the number of security points. The value for K is randomly generated. The sub-process continues by generating, using the online server 4, a t variable that represents the time to update the plurality of security points 42 for the same user account 43. The t variable is the renewal time displayed in minutes, wherein t specifies the interval at which the system creates a new plurality of security points 42 on the same edited document 46. The sub-process continues by generating, using the online server 4, a m variable that represents the user account 43 name. For example, if the account user has the name John, then m = John. The sub-process continues by generating, using the online server 4, a c variable that represents the edited document 46 reference number. For example, if the reference number for the document is ABC1234 then c = ABC1234. The sub-process continues by generating, using the online server 4, a n variable that represents the number of cells integrated along the edited document 46. The n variable is equal to x*y. For example, if the grid selected for an edited document 46 is 4 columns by 5 rows then x = 4 and y = 5 and n therefore = 20.

In reference to FIG. 9, a sub-process of the method of the present invention enables the plurality of security points 42 to be randomly generated and associated with each user account 43. To that end, the sub-process begins by prompting checking, using the online server 4, that K is less than the sum of x plus y minus 2. This design ensures that the number of security points, K, is never larger than the number of cells, c. The sub-process continues by calculating, using the online server 4, n wherein n is x times y. The sub-process continues by generating, using the online server 4, a variable Z wherein Z equals the sum of 2 to the power of g. Z provides the online server 4 a numerical value for the plurality of security points 42 on an edited document 46, which may be later compared. The sub-process continues by generating, using the online server 4, a matrix g which includes K number of random variables wherein each variable is different and selected from 1 to n. The matrix g is always as large as the number of security points generated. Further, each security point is a generated number that never repeats or is larger than the number of cells, c. This design ensures that each security point has a numerical value that is associated with an imaginary grid generated along an edited document 46. Each cell on the document wherein a security point’s numerical value matches up, the logo or dot is positioned. For example, for a 4 by 5 table with a total number of 20 cells, each cell is assigned a number starting at 1 and going up to 20 in sequential order. The cells are numbered starting from left to right and then moving downwards after the row is filled. The matrix g of the plurality of security points 42 is generated wherein g = (1, 3, 12, 13). Therefor the cells associated with 1, 3, 12 and 13 will depict a dot or logo within the matching cells on the edited document 46. Furthermore, Z = (2^1) + (2^3) + (2^12) + (2^13) = 2 + 8 + 4096 + 8192 = 12298.

In reference to FIG. 9, a sub-process of the method of the present invention enables the plurality of security points 42 to be randomly generated and associated with each user account 43 without repeating the placement of the plurality of security points 42. To that end, the sub-process begins by prompting checking, using the storage database 41, c against previous values for c associated with the user account 43). This design ensures that if the document reference string does not match an already generated document reference string for that user account 43. The sub-process continues by checking, using the storage database 41, m against previous values for m associated with the user account 43). This design ensures that the name string does not match and already generated name string for that user account 43. The sub-process continues by checking, using the storage database 41, z against previous values for z associated with the user account 43). This design ensures that the value calculated for the plurality of security points 42 does not equal the number already generated for a plurality of security points 42. The sub-process continues by generating, using the online server 4, a new value for c, m, or z if c, m, or z equals a previous value for c, m, or z. This ensures that as long as all of these variable values do not match their associated variable values the security points generated are valid and may be used. However, if all the values for each variable match their associated variable’s values, then a new set of plurality of security points 42 will be generated for the edited document 46. It can be seen that the present invention is a system and method for integrating security points into documents accessed by a user, enabling the user to easily be tracked down if the document is later leaked.

This design ensures that each security point 42 has a numerical value that is associated with an imaginary grid generated along an edited document 46. Each cell on the edited document 46 wherein a security point’s numerical value matches up, the logo or dot is positioned. For example, for a 4 by 5 table with a total number of 20 cells, each cell is assigned a number starting at 1 and going up to 20 in sequential order. The cells are numbered starting from left to right and then moving downwards after the row is filled. The matrix g of the plurality of security points 42 is generated wherein g = (1, 3, 12, 13). Therefor the cells associated with 1, 3, 12 and 13 will depict a dot or logo within the matching cells on the edited document 46. Furthermore, Z = (2^1) + (2^3) + (2^12) + (2^13) = 2 + 8 + 4096 + 8192 = 12298.

Although the invention has been explained in relation to its preferred embodiment, it is to be understood that many other possible modifications and variations can be made without departing from the spirit and scope of the invention as hereinafter claimed.

What is claimed is:

1. A system for generating traceable security points on compromised documents comprising:
a user device;
an administrator device;
a camera;
an online server;
the online server comprising a storage database, a plurality of security points, a user account, an administrator account, at least one clean document, at least one edited document, and at least one compromised document;
the camera being in remote communication with the user device and the administrator device;
the user device and administrator device being in remote communication with the online server;
the user device being able to access at least one edited document and at least one compromised document on the online server; and
the administrator device being able to access at least one clean document, at least one edited document, and at least one compromised document on the online server.

2. The system for generating traceable security points on compromised documents as claimed in claim 1 comprising:
the storage database further comprising a plurality of security points data; and
the plurality of security points data being associated with a plurality of security points on at least one edited document or at least one compromised document.

3. The system for generating traceable security points on compromised documents as claimed in claim 1 comprising:
the user account being associated with the user device; and
the administrator account being associated with the administrator device.

4. The system for generating traceable security points on compromised documents as claimed in claim 1 comprising:
the camera recording a clean document;
the camera recording a compromised document;
the administrator device uploading the clean document to the online server via the administrator account; and
the administrator device uploading the compromised document to the online server via the administrator account.

5. The system for generating traceable security points on compromised documents as claimed in claim 4 wherein the plurality of security points being integrated within the edited and compromised document.

6. A method for generating traceable security points on compromised documents comprising:
scanning, using a camera, at least one clean document;
sending, using an administrator device, a clean document to an online server;
editing, using the online server, the clean document to include a plurality of security points once the clean document is opened by a user account;
storing, using the online server, a plurality of security points data in a storage database;
leaking, using the user account, an edited document;
scanning, using the camera, a compromised document;
sending, using the administrator device, the compromised document to the online server; and
identifying, using the online server, the user account whose plurality of security points data matches the compromised document.

7. The method for generating traceable security points on compromised documents as claimed in claim 6 comprising:
generating, using the administrator device, an administrator account on the online server; and
enabling, using the administrator account, the administrator device to access the online server.

8. The method for generating traceable security points on compromised documents as claimed in claim 6 comprising:
generating, using the user device, a user account on the online server; and
enabling, using the user account, the user device to access online server.

9. The method for generating traceable security points on compromised documents as claimed in claim 8 wherein accessing, using the user account, at least one edited document on the online server.

10. The method for generating traceable security points on compromised documents as claimed in claim 6 comprising:
uploading, using the administrator account, a logo; and
utilizing, using the administrator account, the logo as a security point.

11. The method for generating traceable security points on compromised documents as claimed in claim 10 wherein personalizing, using the online server, the plurality of security points on the edited document based on which user account accessed the edited document.

12. The method for generating traceable security points on compromised documents as claimed in claim 11 wherein generating, using the administrator device, a different plurality of security points on the edited document if the user account prints the edited document.

13. The method for generating traceable security points on compromised documents as claimed in claim 11 wherein generating, using the administrator device, a different plurality of security points on the edited document if the user account views the edited document.

14. The method for generating traceable security points on compromised documents as claimed in claim 11 wherein generating, using the administrator device, a different plurality of security points on the edited document if the user account downloads the edited document.

15. The method for generating traceable security points on compromised documents as claimed in claim 6 comprising:
analyzing, using the online server, the compromised document with respect to the plurality of security points data in the storage database; and
notifying, using the online server, the administrator account of the user account that distributed the compromised document.

16. The method for generating traceable security points on compromised documents as claimed in claim 6 comprising:
generating, using the online server, an x variable that represents the x-axis;
generating, using the online server, a y variable that represents the y axis;
generating, using the online server, a K variable that represents the number of security points;
generating, using the online server, a t variable that represents the time to update the plurality of security points for the same user account;
generating, using the online server, a m variable that represents the user account name;
generating, using the online server, a c variable that represents the edited document reference number; and
generating, using the online server, a n variable that represents the number of cells integrated along the edited document.

17. The method for generating traceable security points on compromised documents as claimed in claim 16 comprising:
checking, using the online server, that K is less than the sum of x plus y minus 2;
calculating, using the online server, n wherein n is x times y;
generating, using the online server, a variable Z wherein Z equals the sum of 2 to the power of g; and
generating, using the online server, a matrix g which includes K number of random variables wherein each variable is different and selected from 1 to n.

18. The method for generating traceable security points on compromised documents as claimed in claim 17 comprising:
checking, using the storage database, c against previous values for c associated with the user account;
checking, using the storage database, m against previous values for m associated with the user account;
checking, using the storage database, z against previous values for z associated with the user account; and
generating, using the online server, a new value for c, m, or z if c, m, or z equals a previous value for c, m, or z.
